(19) United States
(12) Patent Application Publication
(10) Pub. No.: US 2004/0241576 A1
(43) Pub. Date: Dec. 2, 2004

(54) Negative resist material and method for forming resist pattern

(76) Inventors: Jyun Iwashita, Kawasaki-shi (JP); Toshikazu Tachikawa, Kawasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/808,425

(22) Filed: Mar. 25, 2004

(30) Foreign Application Priority Data
Mar. 26, 2003 (JP) 2003-084981

(51) Int. Cl. G03C 1/76

(52) U.S. Cl. 430/270.1

(57) ABSTRACT

Disclosed is a negative-working resist material comprising a polymeric compound having a polymerizable unit comprising at least a hydroxy acid moiety and a main chain moiety bound to each other via only one carbon in the carbon skeleton of the hydroxy acid, wherein a space of such size as to permit an alkali substance to approach a linkage between the hydroxy acid moiety and the main chain moiety is not present between the two moieties. The material can be used as a negative-working resist material containing the polymeric compound and an acid generating agent, which is easily synthesized and excellent in shelf stability and processing stability upon alkali treatment.

### CROSS-REFERENCE TO RELATED APPLICATIONS

This application claims the benefit of the priority of Japanese Patent Application No. 2003-084981, filed on Mar. 26, 2003, and the disclosure of which is incorporated by reference herein in its entirety.

### BACKGROUND OF THE INVENTION

1) Field of the Invention

The present invention relates to a negative-working resist material containing a polymeric compound and an acid generating agent.

2) Description of the Related Art

To the present, a chemically amplified negative-working resist containing an acid generating agent, an alkali-soluble resin such as novolak resin and polyhydroxystyrene, and a crosslinking agent such as melamine resin and urea resin as basic ingredients is known (For example, Patent Document 1: JP-P-H8-3635 B). The negative-working resist is a resist wherein the alkali-soluble resin undergoes crosslinking reaction by the action of an acid generated upon irradiation with radiations, to render light-exposed regions alkali-insoluble, and light-unexposed regions are dissolved with an alkali, to form a negative pattern.

Such a chemically amplified negative-working resist comprising a combination of an acid generating agent, an alkali-soluble resin and an amino resin is satisfactorily usable in a process using i line or KrF excimer laser light (248 nm) as a light source, but is not always satisfactory as a lithographic resist (negative-working resist for ArF) using ArF excimer laser light (193 nm) developed in recent years to cope with high integration of semiconductor elements.

Thus, the following negative-working resists for ArF have been proposed: a negative-working resist for ArF, wherein a crosslinking agent composed of an alicyclic polyvalent alcohol and an acid generating agent are incorporated into a basic resin component that is a 5-methylene-bicyclo[2.2.1]-2-heptane/maleic acid copolymer esterified in one carboxyl group in the maleic acid moiety (For example, Non-patent Document 1: J. Photopolym. Sci. Tech. 10(4), p.579-584 (1997)), a negative-working resist for ArF, wherein the same crosslinking agent and acid generating agent as described above are incorporated into a basic resin component that is a copolymer of an acrylate having an epoxy-containing cyclic hydrocarbon group in its ester moiety and an acrylate having a carboxyl-containing cyclic hydrocarbon group in its ester moiety (For example, Non-patent Document 2: J. Photopolym. Sci. Tech. 11(3), p.507-512 (1998)), and a negative-working resist for ArF, wherein the same crosslinking agent and acid generating agent as described above are incorporated into a basic resin component that is a copolymer of an acrylate having a hydroxyl-containing cyclic hydrocarbon group in its ester moiety and an acrylate having a carboxyl-containing cyclic hydrocarbon group in its ester moiety (For example, Non-patent Document 3: SPIE Advances in Resist Technology and Processing XIV 3333, p.417-424 (1998)).

These negative-working resists for ArF are characterized in that a carboxyl-containing, bridged polycyclic hydrocarbon group is introduced into resin for improving transmittance of the ArF excimer laser light (193 nm) through the basic resin component and simultaneously making it alkali-soluble, or in that an epoxy group or an alcoholic hydroxyl group is introduced to effect crosslinking.

In the negative-working resists having such compositions, negative patterns may be formed as a result of generation of ester or ether linkages between the crosslinking agent and the basic resin component in the presence of an acid by ArF excimer laser light. However, non-crosslinked carboxyl or alcoholic hydroxyl groups remaining in light-exposed regions are swollen upon alkali development thereby rounding the resist patterns.

In order to overcome such a problem, there has recently been proposed a radiosensitive composition containing at least a polymer having a repeating unit represented by the following formula (5) and an acid generating agent (For example, Patent Document 2: JP-P-2001-174993 A). There has also proposed a polymer having a repeating unit represented by the following general formula (6).

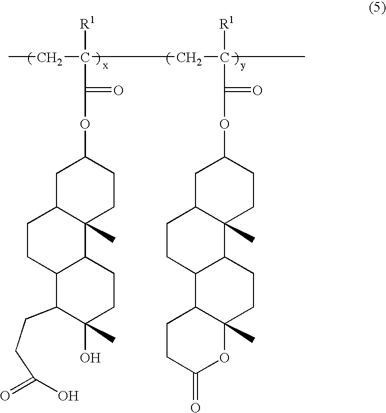

In the general formula (5), R¹ and R² each represent a hydrogen atom or a methyl group, x and y each represent an arbitrary number satisfying the relationships x+y=1, 0<x≦1, and 0≦y<1, and the weight-average molecular weight of the polymer is 1,000 to 500,000.

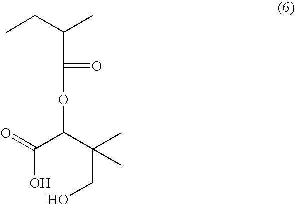

### SUMMARY OF THE INVENTION

The polymeric compound having the polymerizable unit of the general formula (5) contains a hydroxy acid moiety at the end of one side chain. The existence of this hydroxyl acid moiety makes the polymeric compound alkali-soluble. When an acid generated by light exposure acts on a part of this polymeric compound, the hydroxy acid group in that part reacts to constitute a ring, which makes the part alkali-insoluble. It is deduced that such constitution and action make this polymeric compound applicable as a negative-working resist material. However, the hydroxy acid moiety is also liable to react to constitute a ring with the lapse of time, i.e. the moiety tends to form a lactone ring. As a result of such a reaction, the compound undesirably acquires alkali insolubility before the light exposure, which lead to loss of the photosensitivity as a resist composition. Thus, the polymeric compound represented by the general formula (5) has a problem of insufficient shelf stability due to such tendency of spontaneous lactone formation. The polymeric compound is also unsuitable for mass production due to the difficulty in the synthesis thereof.

In the compound represented by the general formula (6), on the other hand, a hydroxy acid moiety present in a side chain binds to a main chain moiety of the polymerizable unit via only one carbon in the carbon skeleton, and it is deduced that such one-point support contributes to keeping both ends of the hydroxy acid moieties off from each other. Such one-point support thus prevents the hydroxy acid moiety from undergoing ring closure reaction with the lapse of time, thus securing the shelf stability of the polymeric compound as a resist composition material. Thus, the compound represented by the general formula (6) has solved the problem of shelf stability and difficult synthesis. However, due to its poor processing stability upon alkali treatment, there is a problem of low resolution and low etching resistance.

The present invention has been achieved with a view to the above problems, and the object of the invention is to provide a negative-working resist material solving the problem.

To solve the problem in the prior art, the present inventors made extensive study, and found out that stability of the negative-working resist material upon alkali treatment may be improved by employing as a constituent thereof a polymer compound having a structure wherein a hydroxy acid moiety is bound to a main chain moiety (polymerizable moiety) via only one carbon in the carbon skeleton of the hydroxy acid thereby improving shelf stability, and further a space of such size as to permit an alkali substance to approach a linkage between the hydroxy acid moiety and the main chain moiety is not present between the two moieties.

The negative-working resist material according to the present invention is characterized by containing at least the aforementioned polymeric compound and an acid generating agent. The present invention provides a negative-working resist material which is superior in shelf stability, excellent in resolution, and capable of mass production.

These and other objects, features, and advantages of the present invention will become apparent from the following detailed descriptions.

### DETAILED DESCRIPTIONS

The present invention is described below in detail. Commercially available products may be used for each of the materials mentioned below, unless otherwise specified.

The negative-working resist material according to the present invention contains a polymeric compound having a polymerizable unit comprising at least a hydroxy acid moiety and a polymerizable moiety (main chain moiety) bound to each other via only one carbon of the carbon skeleton of the hydroxy acid. The main chain moiety may be any main chain moiety insofar as it has a structure capable of forming a polymer by polymerization, and preferable examples thereof may include a vinyl monomer, an acrylic acid type monomer, a norbornene type monomer, and main chain moieties derived from these compounds.

The connection between the hydroxy acid and the main chain moiety via only one carbon of the carbon skeleton of the hydroxyl acid results in a great range of width (flexibility) of the spatial arrangement of two lactone-formable hydroxy acid ends of the hydroxyl acid, i.e. two functional groups (a hydroxyl group and a carboxyl group). Such a connection can thus lower tendency of spontaneous dehydration and lactone formation. As a result, shelf stability is estimated to be improved. The width (flexibility) of the spatial arrangement of the two functional groups can be estimated with a calculatory simulator.

The polymeric compound is characterized in that a space of such size as to permit an alkali substance to approach a linkage between the hydroxy acid moiety and the main chain moiety is not present between the two moieties. When a space of such size as to permit an alkali substance to approach a linkage between the hydroxy acid moiety and the main chain moiety is present between the two moieties, an alkali substance in production of resin enters the space between the hydroxy acid moiety and the main chain moiety, to cleave a linkage between the hydroxyl acid moiety and the main chain moiety. As a result, the resulting resin would not function as a negative-working resist.

The approach of the alkali substance between the hydroxyl acid moiety and the main chain moiety may be inhibited by, for example, producing the polymeric compound having high carbon density per unit volume of the polymerizable unit. A preferable quantitative expression of carbon density is carbon density (Ohnishi parameter) per unit volume of the polymerizable unit. Generally, higher carbon density (that is, lower Ohnishi parameter) also leads to an improved etching resistance, which is also preferable. The Ohnishi parameter (J. Electrochem Soc. 143, 130(1983), H. Gokan, S. Esho, and Y. Ohnishi)) is generally used for expressing carbon density, and is specifically determined by (number of C, H, and O atoms in total)/(number of C atoms−number of O atoms).

Such high carbon density may be achieved in various modes, preferably by directly bonding the hydroxy acid moiety to the main chain via only one carbon in the carbon skeleton of the hydroxyl acid moiety or via a cyclic moiety. The cyclic moiety is preferably a polycyclic highly bulky cycle. This is because by steric effect (steric hindrance) together with an increase in carbon density, the space between the hydroxy acid moiety and the main chain moiety can be confined to prevent an alkali substance from approaching the space.

Examples of polymerizable units wherein the hydroxy acid moiety is bound to the main chain moiety directly or via a cyclic moiety may include units represented by the following general formulae (1), (2), and (3).

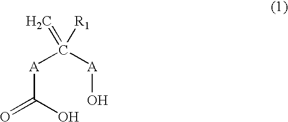

In the general formula (1), R₁ is a hydrogen atom or an alkyl group having 1 to 5 carbon atoms, and A is a nitrogen atom, a sulfur atom, or an alkyl group having 1 to 21 carbon atoms. The alkyl group referred to herein is an alkyl group in a broad meaning, which includes not only an alkyl group in an ordinary meaning thereof but also a fluoroalkyl group etc. whose hydrogen atoms are replaced partially or wholly by fluorine atoms.

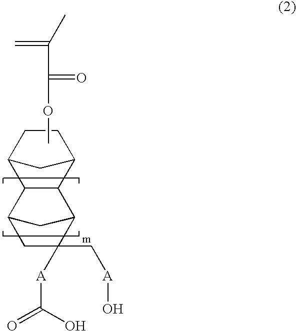

In the general formula (2), R₁ is a hydrogen atom or an alkyl group having 1 to 5 carbon atoms, and A is a nitrogen atom, a sulfur atom, or an alkyl group having 1 to 21 carbon atoms. The alkyl group referred to herein is an alkyl group in a broad meaning, which includes not only an alkyl group in an ordinary meaning thereof but also a fluoroalkyl group etc. whose hydrogen atoms are replaced partially or wholly by fluorine atoms. m is an integer of 0 to 3.

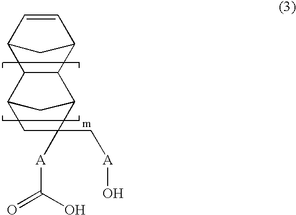

In the general formula (3), A is a nitrogen atom, a sulfur atom, or an alkyl group having 1 to 21 carbon atoms. The alkyl group referred to herein is an alkyl group in a broad meaning, which includes not only an alkyl group in an ordinary meaning thereof but also a fluoroalkyl group etc. whose hydrogen atoms are replaced partially or wholly by fluorine atoms. m is an integer of 0 to 3.

In the general formulae representing the polymerizable units, A may preferably be a group represented by the following general formula (4):

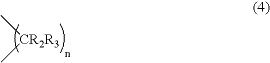

In the general formula (4), each of R₂ and R₃ is an alkyl group having 1 to 3 carbon atoms, and n is an integer of 1 to 3. The alkyl group referred to herein is an alkyl group in a broad meaning, which includes not only an alkyl group in an ordinary meaning thereof but also a fluoroalkyl group etc. whose hydrogen atoms are replaced partially or wholly by fluorine atoms.

When the alkyl group is a fluoroalkyl group, transparency to irradiated light is increased to permit irradiated light to reach the bottom of a resist layer, resulting in higher resolution.

In the general formulae representing the polymerizable units, A may preferably be an alkyl group having 1 to 5 carbon atoms. The alkyl group referred to herein is an alkyl group in a narrow meaning. The “alkyl group in a narrow meaning” refers to an alkyl group consisting of carbon atom(s) and hydrogen atoms.

Examples of polymeric compounds used in the negative-working resist material of the present invention are as follows:

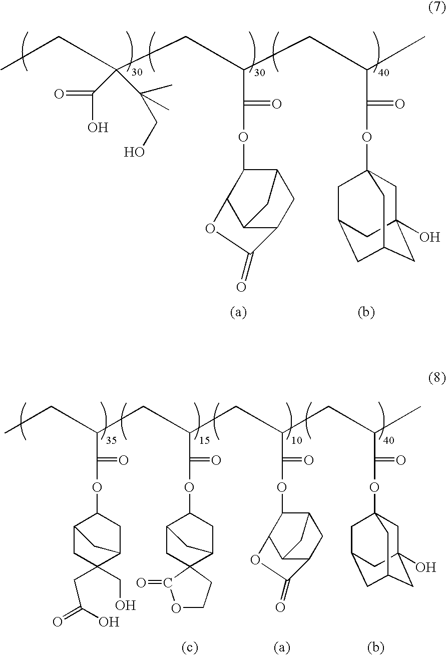

Presence of the unit (a) in the general formulae (7) and (8) may bring about an effect of improved adhesion to a sublayer. Presence of the unit (b) may bring about effects of an improved etching resistance and adjustment of hydrophilicity.

The hydroxy acid moiety may be obtained by hydrolysis treatment of a lactone ring, but not every lactone ring may be opened by the hydrolysis treatment, and 50 to 80 mol % lactone ring may be opened to form hydroxy acid. The remaining 20 to 50 mol % lactone ring may remain as the unit (c) in the form of a closed lactone ring.

The negative-working resist material of the present invention contains a least the aforementioned polymeric compound and an acid generating agent. The “acid generating agent” refers to a compound which generates an acid upon irradiation with radiations. The acid generating agent to be used may suitably be selected from known acid generating agents used in conventional chemically amplified negative-working photoresists. In particular, an onium salt having an alkyl sulfonate ion or a halogen-substituted alkyl sulfonate ion as an anion is preferable. A preferable cation for this onium salt may include, for example, phenyl iodonium and sulfonium which may be substituted with a lower alkyl group such as methyl group, ethyl group, propyl group, n-butyl group and tert-butyl group or a lower alkoxy group such as methoxy group and ethoxy group, as well as dimethyl(4-hydroxynaphthyl) sulfonium.

The anion may preferably be a fluoroalkyl sulfonate ion having an alkyl group of about 1 to 10 carbon atoms whose hydrogen atoms are partially or wholly replaced by fluorine atoms. The anion may more preferably be a fluoroalkyl sulfonate ion having an alkyl group of about 1 to 5 carbon atoms whose hydrogen atoms are wholly replaced by fluorine atoms, because the strength of the sulfonic acid tends to be decreased as the length of the carbon chain is increased and the degree of fluorination (proportion of fluorine atoms in the alkyl group) is decreased.

Examples of such onium salts may include trifluoromethane sulfonate or nonafluorobutane sulfonate of diphenyl iodonium, trifluoromethane sulfonate or nonafluorobutane sulfonate of bis(4-tert-butylphenyl)iodonium, trifluoromethane sulfonate or nonafluorobutane sulfonate of triphenyl sulfonium, trifluoromethane sulfonate or nonafluorobutane sulfonate of tri(4-methylphenyl)sulfonium, trifluoromethane sulfonate or nonafluorobutane sulfonate of dimethyl(4-hydroxynaphthyl)sulfonium, etc. In the present invention, the acid generating agent may be used alone or as a mixture of two or more thereof.

For the purpose of further improving the density of crosslinkage and improving the shape accuracy, resolution and dry etching resistance of resist patterns, the negative-working resist material of the present invention may contain a crosslinking agent if desired.

The crosslinking agent is not particularly limited, and suitable one for use may be selected from known crosslinking agents used in conventional chemically amplified negative-working resists. Examples of such crosslinking agents may include alicyclic hydrocarbons containing a hydroxyl group and/or a hydroxyalkyl group, such as 2,3-dihydroxy-5-hydroxymethyl norbornane, 2-hydroxy-5,6-bis(hydroxymethyl) norbornane, cyclohexane dimethanol, 3,4,8 (or 9)-trihydroxy tricyclodecane, 2-methyl-2-adamantanol, 1,4-dioxane-2,3-diol and 1,3,5-trihydroxycyclohexane, or oxygen-containing derivatives thereof; and compounds prepared by reacting formaldehyde, or formaldehyde and a lower alcohol, with an amino group-containing compound such as melamine, acetoguanamine, benzoguanamine, urea, ethylene urea and glycoluril and then substituting the hydrogen atom of the amino group with a hydroxymethyl group or lower alkoxymethyl group, such as hexamethoxymethyl melamine, bismethoxymethyl urea, bismethoxymethyl bismethoxyethylene urea, tetramethoxymethyl glycoluril, tetrabutoxymethyl glycoluril etc., among which tetrabutoxymethyl glycoluril is particularly preferable. In the present invention, the crosslinking agent may be used alone or as a mixture of two or more thereof.

The composition of the present invention is preferably used in a form of solution containing each of the components dissolved in a solvent. Examples of the solvent may include ketones such as acetone, methyl ethyl ketone, cyclohexanone, methyl isoamyl ketone and 2-heptane; polyvalent alcohols and derivatives thereof such as ethylene glycol, ethylene glycol monoacetate, diethylene glycol, diethylene glycol monoacetate, propylene glycol, propylene glycol monoacetate, dipropylene glycol or dipropylene glycol monoacetate, as well as their monomethyl ether, monoethyl ether, monopropyl ether, monobutyl ether or monophenyl ether; cyclic ethers such as dioxane; esters such as methyl lactate, ethyl lactate, methyl acetate, ethyl acetate, butyl acetate, methyl pyruvate, ethyl pyruvate, methyl methoxypropionate and ethyl ethoxypropionate; and amide solvents such as N,N-dimethylformamide, N,N-dimethylacetamide and N-methyl-2-pyrrolidone. The solvent may be used alone or as a mixture of two or more thereof. The solvent may be used as a mixed solvent with water.

If desired, the negative-working resist material of the present invention may further contain miscible additives, e.g., conventional additives for improving properties of the resist layer such as an additional resin, a plasticizer, a stabilizer, a colorant and a surfactant.

The negative-working resist material of the present invention is highly transparent to ArF excimer laser light and highly resistant to dry etching.

The negative-working resist material of the present invention may be used in accordance with a resist pattern forming method in conventional photoresist techniques. A preferable method may be as follows; a solution of the resist composition is applied by a spinner or the like onto a supporting substrate such as a silicone wafer and then dried to form a photosensitive layer. The resulting layer is then irradiated with ArF excimer laser light from a light exposure device for miniaturizing projection via a mask having a desired pattern, and then heated. The layer is then developed with an aqueous alkaline solution such as 0.01 to 10 weight % aqueous tetramethyl ammonium hydroxide. With this formation method, an image accurate to the mask pattern can be obtained.

The substrate to which the negative-working resist material of the present invention is applied is not particularly limited, and may be any of various substrates to which conventional negative-working resists are applied, for example, a silicone wafer, a silicone wafer provided with an organic or inorganic anti-reflection film, and a glass substrate.

### EXAMPLES OF THE INVENTION

The present invention is further described in detail with reference to examples shown below. However, the present invention is not limited to the examples.

### POLYMERIC COMPOUND SYNTHESIS EXAMPLE 1

A polymeric compound was synthesized with the monomers represented by the following general formulae (9), (10), and (11):

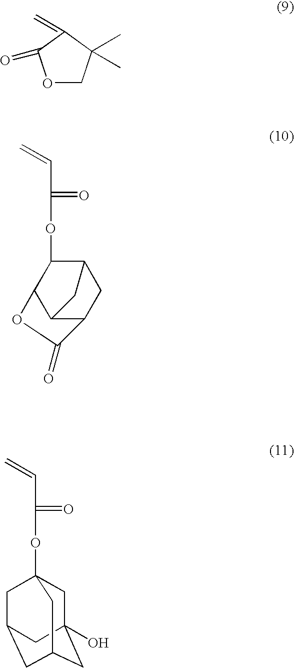

3.0 g (23.8 mmol) of γ,γ-dimethyl-α-methylene-γ-butyrolactone represented by the general formula (9), 4.95 g (23.8 mmol) of norbornene lactone acrylate represented by the general formula (10), 7.04 g (31.7 mmol) of adamantane alcohol acrylate represented by the general formula (11) and 0.6 g (2.60 mmol) of a polymerization initiator dimethyl azobisisobutyrate were dissolved in 200 g of THF (tetrahydrofuran). The solution was bubbled with nitrogen for about 10 minutes, and then stirred for 5 hours under heating on a water bath at 75 to 80° C. Then, the reaction mixture was dissolved in 75 ml of THF and precipitated with a mixed solvent of 800 ml of heptane and 200 ml of isopropyl alcohol to recover particulate crystals. The weight-average molecular weight of the resulting resin was about 3400, and the degree of dispersion was 1.34.

10 g of the resulting resin was dissolved in 600 g of THF. Then 300 g of 0.13 N aqueous sodium hydroxide was added dropwise thereto, and the mixture was stirred for 6 hours. Thereafter, the solution was neutralized with 0.05 N HCl until the pH was reduced to about 4. Then, the reaction solution was extracted with 1000 ml of ethyl acetate, and the ethyl acetate layer was concentrated, dried, dissolved in 100 ml of THF and precipitated with 1000 ml of heptane to recover particulate crystals. The yield was 5.9 g.

### POLYMERIC COMPOUND SYNTHESIS EXAMPLE 2

A polymeric compound was synthesized with the monomers represented by the following general formulae (11) and (12):

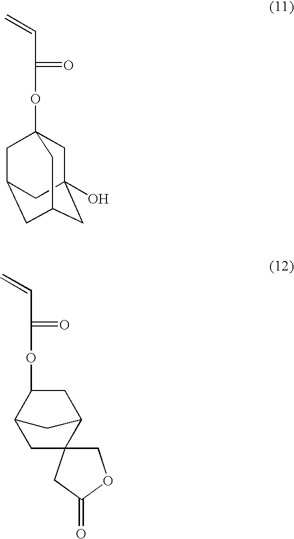

7.66 g (32.5 mmol) of spirolactone acrylate represented by the general formula (12), 4.80 g (21.6 mmol) of adamantane alcohol acrylate represented by the general formula (11), and 0.42 g of a polymerization initiator azobisisobutyronitrile were dissolved in 150 ml of THF (tetrahydrofuran). The solution was bubbled with nitrogen for about 10 minutes, and then stirred for 4 hours under heating on a water bath at 70° C. Then, the reaction mixture was dissolved in 100 ml of THF and precipitated with a mixed solvent of 800 ml of heptane and 200 ml of isopropyl alcohol to recover particulate crystals. The weight-average molecular weight of the resulting resin was about 6,500, and the degree of dispersion was 1.70.

10 g of the resulting resin was dissolved in 600 ml of THF. Then 250 ml of 0.1 N aqueous sodium hydroxide was added dropwise thereto, and the mixture was stirred for 6 hours. Thereafter, the pH of the solution was adjusted to about 4 by adding 0.04 N HCl thereto under stirring. Then, the reaction solution was extracted with 1,000 ml of ethyl acetate, and the ethyl acetate layer was concentrated, dried, dissolved in 150 ml of THF and precipitated with 900 ml of heptane to recover particulate crystals. The yield was 5.6 g.

### POLYMERIC COMPOUND SYNTHESIS EXAMPLE 3

A polymeric compound was synthesized with the monomers represented by the following general formulae (10), (11), and (12):

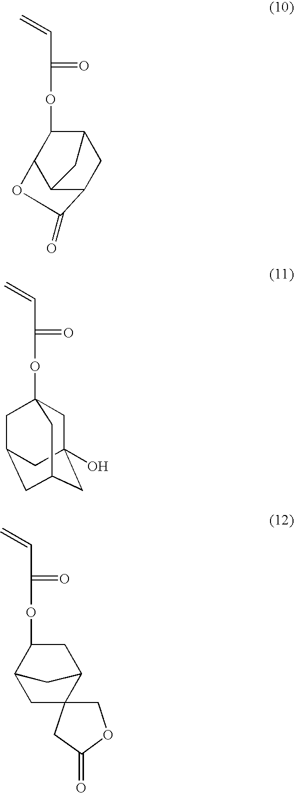

10 g (42.4 mmol) of spirolactone acrylate represented by the general formula (12), 1.76 g (8.46 mmol) of norbornene lactone acrylate represented by the general formula (10), 7.53 g (33.9 mmol) of adamantane alcohol acrylate represented by the general formula (11), and 0.84 g of a polymerization initiator dimethyl azobisisobutyrate were dissolved in 200 ml of THF (tetrahydrofuran). The solution was bubbled with nitrogen for about 10 minutes, and then stirred for 4 hours under heating on a water bath at 70° C. Then, the reaction mixture was dissolved in 150 ml of THF and precipitated with a mixed solvent of 800 ml of heptane and 200 ml of isopropyl alcohol, to recover particulate crystals. The weight-average molecular weight of the resulting resin was about 3,000, and the degree of dispersion was 1.84.

10.5 g of the resulting resin was dissolved in 600 ml of THF. Then 300 ml of 0.1 N aqueous sodium hydroxide was added dropwise thereto, and the mixture was stirred for 6 hours. Thereafter, the pH of the solution was adjusted to about 4 by adding 0.05 N HCl thereto under stirring. Then, the reaction solution was extracted with 1000 ml of ethyl acetate. The extract was admixed with 500 ml of THF, which was then dried, dissolved in 180 ml of THF and precipitated with 1000 ml of heptane to recover particulate crystals. The yield was 5.9 g.

### COMPARATIVE POLYMERIC COMPOUND SYNTHESIS EXAMPLE 1

A polymeric compound was synthesized with the monomers represented by the following general formulae (11) and (13):

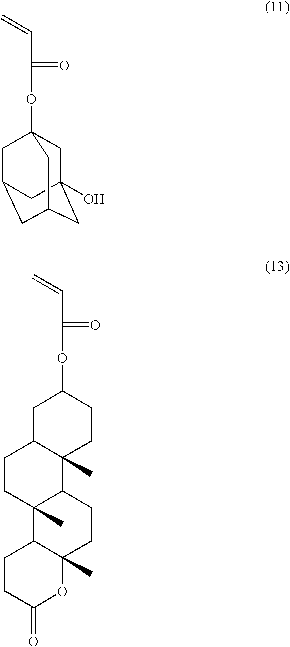

40 g (110.8 mmol) of androsterone lactone monomer represented by the general formula (13), 13.2 g (59.5 mmol) of adamantane alcohol acrylate represented by the general formula (11), and 1.63 g of a polymerization initiator dimethyl azobisisobutyrate were dissolved in 600 ml of THF (tetrahydrofuran). The solution was bubbled with nitrogen for about 10 minutes, and then stirred for 4 hours under heating on a water bath at 70° C. Then, the reaction mixture was dissolved in 150 ml of THF and precipitated with a mixed solvent of 800 ml of heptane and 200 ml of isopropyl alcohol. The precipitates were dissolved in 400 ml of THF and divided into equal halves, each of which was then precipitated with 800 ml of heptane and 100 ml of isopropyl alcohol to recover particulate crystals. The weight-average molecular weight of the resulting resin was about 3000, and the degree of dispersion was 1.52.

42.0 g of the resulting resin was dissolved in 700 ml of THF. Then 400 ml of 0.1 N aqueous sodium hydroxide was added dropwise thereto, and the mixture was stirred for 6 hours. Thereafter, the pH of the solution was adjusted to about 3 to 4 by adding 1200 ml of 0.05 N HCl thereto under stirring. Then, the reaction solution was extracted with 1000 ml of ethyl acetate. The extract was admixed with 500 ml of THF, which was then dried, dissolved in 250 ml of THF and precipitated with 1000 ml of heptane to recover particulate crystals. The yield was 30.0 g.

### COMPARATIVE POLYMERIC COMPOUND SYNTHESIS EXAMPLE 2

A polymeric compound was synthesized with the monomers represented by the following general formulae (11) and (14):

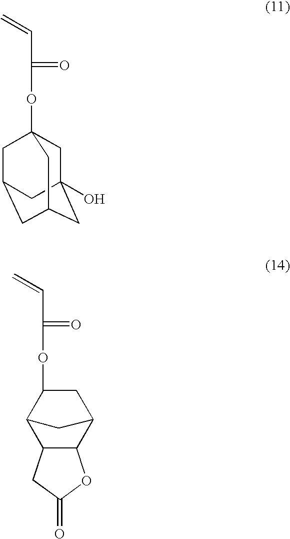

6.12 g (27.6 mmol) of oxatricyclodecane acrylate represented by the general formula (14), 4.0 g (18.0 mmol) of adamantane alcohol acrylate represented by the general formula (11), and 0.42 g of a polymerization initiator dimethyl azobisisobutyrate were dissolved in 150 ml of THF (tetrahydrofuran). The solution was bubbled with nitrogen for about 10 minutes, and then stirred for 4 hours under heating on a water bath at 70° C. Then, the reaction mixture was dissolved in 120 ml of THF and precipitated with a mixed solvent of 800 ml of heptane and 200 ml of isopropyl alcohol to recover particulate crystals. The weight-average molecular weight of the resulting resin was about 2700, and the degree of dispersion was 1.93.

9.0 g of the resulting resin was dissolved in 600 ml of THF. Then 400 ml of 0.1 N aqueous sodium hydroxide was added dropwise thereto, and the mixture was stirred for 6 hours. Thereafter, the pH of the solution was adjusted to about 4 by adding 1030 ml of 0.05 N HCl thereto under stirring. Then, the reaction solution was extracted with 1000 ml of ethyl acetate. The extract was admixed with 500 ml of THF, which was then dried, dissolved in 70 ml of THF and precipitated with 900 ml of heptane to recover particulate crystals. The yield was 3.5 g.

### COMPARATIVE POLYMERIC COMPOUND SYNTHESIS EXAMPLE 3

A polymeric compound was synthesized with the monomers represented by the following general formulae (11), (15), and (16):

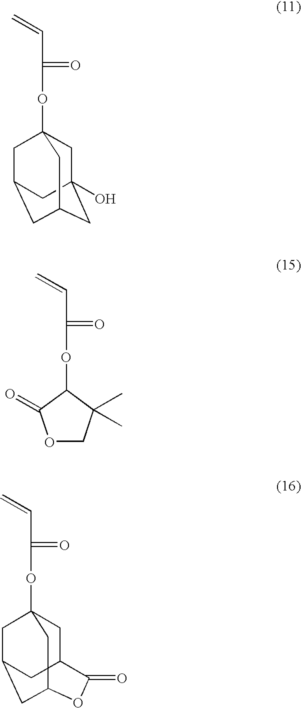

2.40 g (13.0 mmol) of gamma-butyropantolactone acrylate represented by the general formula (15), 6.16 g (26.1 mmol) of adamantane lactone acrylate represented by the general formula (16), 5.80 g (26.1 mmol) of adamantane alcohol acrylate represented by the general formula (11) and 0.42 g of a polymerization initiator dimethyl azobisisobutyrate were dissolved in 150 ml of THF (tetrahydrofuran). The solution was bubbled with nitrogen for about 10 minutes, and then stirred for 4 hours under heating on a water bath at 70° C. Then, the reaction mixture was dissolved in 120 ml of THF and precipitated with a mixed solvent of 800 ml of heptane and 200 ml of isopropyl alcohol to recover particulate crystals. The weight-average molecular weight of the resulting resin was about 3200, and the degree of dispersion was 2.02.

10.0 g of the resulting resin was dissolved in 600 ml of THF. Then 400 ml of 0.1 N aqueous sodium hydroxide was added dropwise thereto, and the mixture was stirred for 6 hours. Thereafter, the pH of the solution was adjusted to about 4 by adding 1000 ml of 0.05 N HCl thereto under stirring. Then, the reaction solution was extracted with 1000 ml of ethyl acetate. The extract was admixed with 500 ml of THF, which was then dried, dissolved in 100 ml of THF and precipitated with 900 ml of heptane to recover particulate crystals. The yield was 1.6 g.

### EXAMPLE 1

The polymeric compound obtained in Polymeric Compound Synthesis Example 1 was used to form a resist pattern. Specifically, an organic anti-reflection coating composition AR-19 (trade name, manufactured by Shipley Company L.L.C.) was applied by a spinner onto a silicon wafer and dried by baking at 215° C. for 60 seconds on a hot plate to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking on a hot plate at 100° C. for 60 seconds to form a resist layer of 300 nm in thickness on the anti-reflection coating.

Then, the resist layer was irradiated with (exposed to) a pattern light of an ArF excimer laser (wavelength 193 nm) from a light exposure system NSR-S302 inline (manufactured by Nikon Corporation) via a mask pattern.

The resist layer was then subjected to PEB treatment under the conditions of 120° C. and 60 seconds. The development treatment was conducted by treatment with 2.38 weight % aqueous TMAH solution for 30 seconds. Thereafter, the resist layer was post-baked at 100° C. for 60 seconds.

The resist pattern was observed under a scanning electron microscope (SEM), and as a result, the resulting resist pattern was excellent. Further, the resist pattern was highly resistant to etching.

### EXAMPLE 2

The polymeric compound obtained in Polymeric Compound Synthesis Example 2 was used to form a resist pattern. Specifically, an organic anti-reflection coating composition AR-19 (trade name, manufactured by Shipley Company L.L.C.) was applied by a spinner onto a silicon wafer and dried by baking at 215° C. for 60 seconds on a hot plate to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking on a hot plate at 100° C. for 60 seconds to form a resist layer of 300 nm in thickness on the anti-reflection coating. Separately, another resist layer was formed in the same manner using the resist solution stored at 15° C. for 2 weeks after preparation.

Then, the resist layer was irradiated with (exposed to) a pattern light of an ArF excimer laser (wavelength 193 nm) from a light exposure system NSR-S302 inline (manufactured by Nikon Corporation) via a mask pattern.

Then, the resist layer was subjected to PEB treatment under the conditions of 120° C. and 60 seconds. The development treatment was conducted by treatment with 2.38 weight % aqueous TMAH solution for 30 seconds. Thereafter, the resist layer was post-baked at 100° C. for 60 seconds.

The resist pattern was observed under a scanning electron microscope (SEM), and as a result, even the negative-working resist after storage at 15° C. for 2 weeks gave an excellent resist pattern comparable to that of the negative-working resist without storage. Further, the resist pattern was highly resistant to etching.

### EXAMPLE 3

The polymeric compound obtained in Polymeric Compound Synthesis Example 3 was used to form a resist pattern. Specifically, an organic anti-reflection coating composition AR-19 (trade name, manufactured by Shipley Company L.L.C.) was applied by a spinner onto a silicon wafer and dried by baking at 215° C. for 60 seconds on a hot plate to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking on a hot plate at 100° C. for 60 seconds to form a resist layer of 300 nm in thickness on the anti-reflection coating.

The resist layer was then irradiated with (exposed to) a pattern light of an ArF excimer laser (wavelength 193 nm) from a light exposure system NSR-S302 inline (manufactured by Nikon Corporation) via a mask pattern.

The resist layer was then subjected to PEB treatment under the conditions of 120° C. and 60 seconds. The development treatment was conducted by treatment with 2.38 weight % aqueous TMAH solution for 30 seconds. Thereafter, the resist layer was post-baked at 100° C. for 60 seconds.

The resist pattern was observed under a scanning electron microscope (SEM), and as a result, the resulting resist pattern was excellent. Further, the resist pattern was highly resistant to etching.

### COMPARATIVE EXAMPLE 1

The polymeric compound obtained in Comparative Polymeric Compound Synthesis Example 1 was used to form a resist pattern. Specifically, an organic anti-reflection coating composition AR-19 (trade name, manufactured by Shipley Company L.L.C.) was applied by a spinner onto a silicon wafer and dried by baking at 215° C. for 60 seconds on a hot plate to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking on a hot plate at 100° C. for 60 seconds to form a resist layer of 300 nm in thickness on the anti-reflection coating. Separately, another resist layer was formed in the same manner using the resist solution stored at 15° C. for 2 weeks after preparation.

The resist layer was then irradiated with (exposed to) a pattern light of an ArF excimer laser (wavelength 193 nm) from a light exposure system NSR-S302 inline (manufactured by Nikon Corporation) via a mask pattern.

The resist layer was then subjected to PEB treatment under the conditions of 120° C. and 60 seconds. The development treatment was conducted by treatment with 0.01 weight % aqueous TMAH solution for 30 seconds. Thereafter, the resist layer was post-baked at 100° C. for 60 seconds.

The resist pattern was observed under a scanning electron microscope (SEM). As a result, when the negative-working resist after storage at 15° C. for 2 weeks was used, the gap among lines was stopped up, thus failing to form a fine pattern. This was probably because flexibility of functional groups of the polymeric compound was so low that the hydroxy acid moiety was closed and the amount of resulting lactone was increased.

### COMPARATIVE EXAMPLE 2

The polymeric compound obtained in Comparative Polymeric Compound Synthesis Example 2 was used to form a resist pattern. Specifically, an organic anti-reflection coating composition AR-19 (trade name, manufactured by Shipley Company L.L.C.) was applied by a spinner onto a silicon wafer and dried by baking at 215° C. for 60 seconds on a hot plate to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking (PAB) on a hot plate at 100° C. for 60 seconds to form a resist layer of 300 nm in thickness on the anti-reflection coating.

Then, the resist layer was irradiated with (exposed to) a pattern light of an ArF excimer laser (wavelength 193 nm) from a light exposure system NSR-S302 inline (manufactured by Nikon Corporation) via a mask pattern.

Then, the resist layer was subjected to PEB treatment under the conditions of 120° C. and 60 seconds. The development treatment was conducted by treatment with 2.38 weight % aqueous TMAH solution for 30 seconds. Thereafter, the resist layer was post-baked at 100° C. for 60 seconds.

When PAB/PEB was 100/120, the light-unexposed region was not dissolved in 2.38 weight % aqueous TMAH solution, thus failing to form a pattern image. Even if PAB/PEB was 90/110, the light-unexposed region was not dissolved in 2.38 weight % aqueous TMAH solution. When PAB/PEB was 80/100, the light-unexposed region was dissolved in 2.38 weight % aqueous TMAH solution, but the resulting pattern was poor in rectangularity.

By lowering the baking temperature, the polymeric compound of so-called two-point support type (OTDMA) could give an image, but its hydroxy acid moiety was easily closed and hardly regulated. It was thus revealed that the entire resist film was undesirably made insoluble when the temperature was not considerably lower than the usual baking temperature.

### COMPARATIVE EXAMPLE 3

Each polymer (4 g) of pantolactones 1, 2, and 3 was stirred in 50 ml of THF (tetrahydrofuran) at a predetermined temperature (70° C.). As a result, THF insolubles were generated in any cases. These insolubles occurred probably because the hydroxy acid moiety in the pantolactone was closed to form lactone.

Then, the polymeric compound obtained in Comparative Polymeric Compound Synthesis Example 3 was used to form a resist pattern. Specifically, an organic anti-reflection coating composition AR-19 (trade name, manufactured by Shipley Company L.L.C.) was applied by a spinner onto a silicon wafer and dried by baking on a hot plate at 100° C. for 60 seconds to form an organic anti-reflection coating of 82 nm in thickness. Then, the above polymeric compound was dissolved in a solvent (propylene glycol monomethyl ether/H₂O=12/1), then mixed with an acid generating agent (TPS-C1: 1%, TPS-C4: 0.67) and an amine (4-phenylpyridine, 0.15%), applied by a spinner onto the anti-reflection coating and dried by pre-baking on a hot plate at 100° C. for 60 seconds to form a resist layer of 300 nm in thickness on the anti-reflection coating.

Then, the resist layer was irradiated with (exposed to) a pattern light of an ArF excimer laser (wavelength 193 nm) from a light exposure system NSR-S302 inline (manufactured by Nikon Corporation) via a mask pattern.

Then, the resist layer was subjected to PEB treatment under the conditions of 120° C. and 60 seconds. Then, the development treatment was conducted by treatment with 0.048% aqueous TMAH solution.

As a result of observation of the resist pattern under a scanning electron microscope (SEM), no resist pattern image was confirmed.

As described above, the negative-working resist material of the present invention is the material at least containing the polymeric compound having the polymerizable unit in which the hydroxy acid moiety and the main chain moiety bound to each other via only one carbon of the carbon skeleton of the hydroxy acid, characterized in that a space of such size as to permit an alkali substance to approach a linkage between the hydroxy acid moiety and the main chain moiety is not present between the two moieties. By such constitution, the present invention can achieve the following effects.

The negative-working resist material of the present invention is excellent in processing stability upon alkali treatment and in resolution.

The negative-working resist material of the present invention is excellent in shelf stability and capable of mass production because of easy synthesis of the polymeric compound used in the negative-working resist material.

The negative-working resist material of the present invention can provide a negative resist excellent in resist pattern and highly resistant to dry etching.

Although the present invention has been described with reference to the preferred examples, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims along with their full scope of equivalents.

References:

Patent Document 1: JP-P-H08-3635 B

Patent Document 2: JP-P-2001-174993 A

Non-patent Document 1: J. Photopolym. Sci. Tech. 10(4), p.579-584 (1997)

Non-patent Document 2: J. Photopolym. Sci. Tech. 11 (3), p.507-512 (1998)

Non-patent Document 3: SPIE Advances in Resist Technology and Processing XIV 3333, p.417-424 (1998)

What is claimed is:

1. A negative-working resist material comprising at least a polymeric compound and an acid generating agent, wherein the polymeric compound has a polymerizable unit having a polymerizable main chain moiety and a hydroxy acid moiety bound to said main chain moiety as a side chain component, the hydroxyl moiety is bound to the main chain moiety via only one carbon in the carbon skeleton of the hydroxy acid, and a space of such size as to permit an alkali substance to approach a binding site between the hydroxy acid moiety and the main chain moiety is not present between the hydroxy acid moiety and the main chain moiety.

2. The negative-working resist material according to claim 1, wherein the hydroxyl acid moiety and the main chain moiety are bound directly to each other by which the space of such size as to permit an alkali substance to approach the binding site therebetween is not present.

3. The negative-working resist material according to claim 1, wherein the hydroxy acid moiety and the main chain moiety are bound to each other via a cyclic moiety, and the space of such size as to permit an alkali substance to approach the binding site therebetween is not present due to the presence of the cyclic moiety.

4. The negative-working resist material according to claim 2, wherein the polymerizable unit is a unit represented by the following general formula (1): 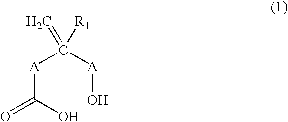
wherein R₁ is a hydrogen atom or an alkyl group having 1 to 5 carbon atoms, and A is a nitrogen atom, a sulfur atom, or an alkyl group having 1 to 21 carbon atoms.

5. The negative-working resist material according to claim 3, wherein the polymerizable unit is a unit represented by the following general formula (2): 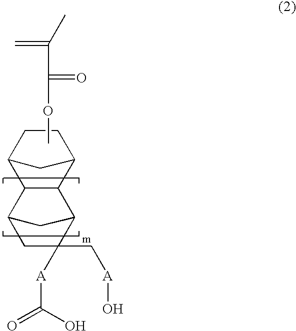
wherein R₁ is a hydrogen atom or an alkyl group having 1 to 5 carbon atoms, A is a nitrogen atom, a sulfur atom, or an alkyl group having 1 to 21 carbon atoms, and m is an integer of 0 to 3.

6. The negative-working resist material according to claim 3, wherein the polymerizable unit is a unit represented by the following general formula (3): 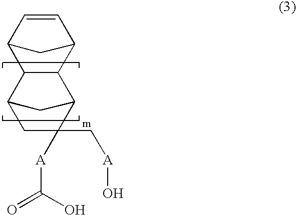
wherein A is a nitrogen atom, a sulfur atom, or an alkyl group having 1 to 21 carbon atoms, and m is an integer of 0 to 3.

7. The negative-working resist material according to claim 4, wherein A in the general formula representing the polymerizable unit is an alkyl group represented by the following general formula (4): 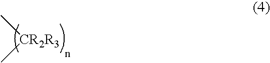
wherein each of R₂ and R₃ is an alkyl group having 1 to 3 carbon atoms, and n is an integer of 1 to 3.

8. The negative-working resist material according to claim 7, wherein the alkyl group represented by R₂ and/or R₃ is a fluoroalkyl group.

9. The negative-working resist material according to claim 4, wherein A in the general formula representing the polymerizable unit is an alkyl group having 1 to 5 carbon atoms.

10. The negative-working resist material according to claim 5, wherein A in the general formula representing the polymerizable unit is an alkyl group represented by the following general formula (4): 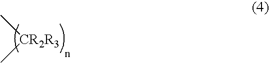
wherein each of R₂ and R₃ is an alkyl group having 1 to 3 carbon atoms, and n is an integer of 1 to 3.

11. The negative-working resist material according to claim 10, wherein the alkyl group represented by R₂ and/or R₃ is a fluoroalkyl group.

12. The negative-working resist material according to claim 5, wherein A in the general formula representing the polymerizable unit is an alkyl group having 1 to 5 carbon atoms.

13. The negative-working resist material according to claim 6, wherein A in the general formula representing the polymerizable unit is an alkyl group represented by the following general formula (4): 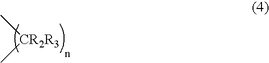
wherein each of R₂ and R₃ is an alkyl group having 1 to 3 carbon atoms, and n is an integer of 1 to 3.

14. The negative-working resist material according to claim 13, wherein the alkyl group represented by R₂ and/or R₃ is a fluoroalkyl group.

15. The negative-working resist material according to claim 6, wherein A in the general formula representing the polymerizable unit is an alkyl group having 1 to 5 carbon atoms.

16. A method of forming a resist pattern, which comprises a step of forming a photoresist pattern by forming at least a photoresist layer with the negative-working resist material of claim 1 on a substrate and subjecting the photoresist layer to light exposure and development treatments to form a predetermined photoresist pattern.
